(19) United States
(12) Patent Application Publication
(10) Pub. No.: US 2010/0062726 A1
(43) Pub. Date: Mar. 11, 2010

(54) Reconfigurable UWB RF Transceiver

(75) Inventors: Yuan Jin Zheng, Singapore (SG); Rajinder Singh, Singapore (SG)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: AGENCY FOR SCIENCE TECHNOLOGY AND RESSEARCH, SINAPORE (SG)

(21) Appl. No.: 12/515,305

(22) PCT Filed: Nov. 22, 2006
(86) PCT No.: PCT/SG06/00359

§ 371 Date: Sep. 15, 2009

(51) Int. Cl. H04B 1/40

(52) U.S. Cl. 455/74

(57) ABSTRACT

A reconfigurable RF transceiver capable of supporting MB-OFDM, DS-UWB, and impulse radio in different operation modes.

### FIELD OF INVENTION

The present invention relates broadly to a reconfigurable radio frequency (RF) Ultra-Wideband (UWB) transceiver. More particular, the present invention relates to a reconfigurable RF UWB transceiver for DS-UWB (Direct Sequence-Ultrawideband), MB-OFDM (Multiband-Orthogonal Frequency Division Multiplexing), and Carrier-less impulse radio UWB communications.

### BACKGROUND

For UWB wireless short range communication applications, such as wireless personnel area networks, wireless sensor networks, video/audio streaming, wireless USB etc., there are different communication schemes in use, including: DS-UWB, MB-OFDM, and Carrier-less impulse radio.

DS-UWB uses ultra-wideband pulses to spread the spectrum of information data, and uses the wide bandwidth transmission trade off with the data rate. In DS-UWB, the conventional up/downconversion scheme using single/mutifrequency tones to shift the modulated UWB signals to different frequency bands is required.

MB-OFDM divides the whole UWB frequency band into 14 subbands. In each subband, a Fast Fourier Transform/Inverse Fast Fourier Transform (FFT/IFFT) based OFDM scheme is employed for data modulation. MB-OFDM can be regarded as an extension of the WLAN (Wireless Local Area Network) 802.11a/g system, and conventional direct conversion techniques can be used for the RF radio design.

Carrier-less impulse radio can be regarded as a truly UWB type transceiver. Carrier-less impulse radio employs pulses to spread and modulate baseband data directly to the RF band, and thus eliminates the requirement for up/down conversion.

Although all of the above three schemes can be employed for UWB applications, the schemes are not compatible. A need therefore exists to provide a transceiver that seeks to address this incompatibility issue.

### SUMMARY

In accordance with a first aspect of the present invention there is provided a reconfigurable RF transceiver capable of supporting MB-OFDM, DS-UWB, and impulse radio in different operation modes.

The RF transceiver may comprise a multitone frequency synthesiser architecture capable of generating multitones for MB-OFDM and DS-UWB.

In a DS-UWB operation mode, pulse spreading and shaping scheme may be implemented in the analog domain.

In a DS-UWB operation mode, a dual band analog DS-UWB modulation and frequency conversion scheme may be implemented.

The RF transceiver may comprise a transmitter module comprising reconfigurable digital to analoge converter modules, reconfigurable multiplier modules, and a reconfigurable driver amplifier module, capable of supporting MB-OFDM, DS-UWB, and impulse radio in the different operation modes.

The transmitter module may further comprise mixers connected to outputs of the respective reconfigurable multiplier modules, wherein outputs from the respective mixers are combined as an input to the reconfigurable driver amplifier module.

The reconfigurable digital to analoge converter modules may be connected to respective reconfigurable multiplier modules, with a selectable bypass connection for the reconfigurable digital to analoge converter modules.

The RF transceiver may comprise a receiver module comprising reconfigurable multiplier modules, reconfigurable low pass filter modules, reconfigurable variable gain amplifier modules, and reconfigurable digital to analoge converter modules, capable of supporting MB-OFDM, DS-UWB, and impulse radio in the different operation modes.

The receiver module may further comprise a low noise amplifier module connected, the output of the low noise amplifier module connected to inputs of respective mixers, outputs of the respective mixers being connected to inputs of the respective low pass filter modules.

Outputs of the respective reconfigurable low pass filter modules may be connected to inputs of the respective reconfigurable variable gain amplifier modules, and outputs of the respective variable gain amplifier modules are connected to respective analoge to digital converter modules.

In a carrier-less impulse radio mode, a pulse position modulated (PPM) modulation and demodulation scheme may be implemented.

The RF transceiver may be capable of supporting scalable data rate applications.

The RF transceiver may be coupled to a baseband processor module.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic circuit diagram of a reconfigurable UWB transceiver.

FIG. 2 shows a schematic circuit diagram of multitone frequency synthesizer for the a reconfigurable UWB transceiver of FIG. 1.

FIG. 3 shows plots of signal streams illustrating a modulation and demodulation scheme for carrier-less impulse radio utilising the UWB transceiver of FIG. 1.

### DETAILED DESCRIPTION

In the described embodiment, a uniform RF transceiver is provided which can be used for design of a radio suitable for MB-OFDM, DS-UWB, and carrier-less impulse radio. Pulse frequency spreading and despreading is adopted to generate the ultra wideband signals and demodulate high rate baseband data. Frequency upconversion and downconversion are utilized to shift the central frequency to the desired subband. The described architecture can adopt the different schemes through switching the corresponding blocks and modulation schemes. The block utility efficiency can be maximized and power consumption can be optimized in the architecture design.

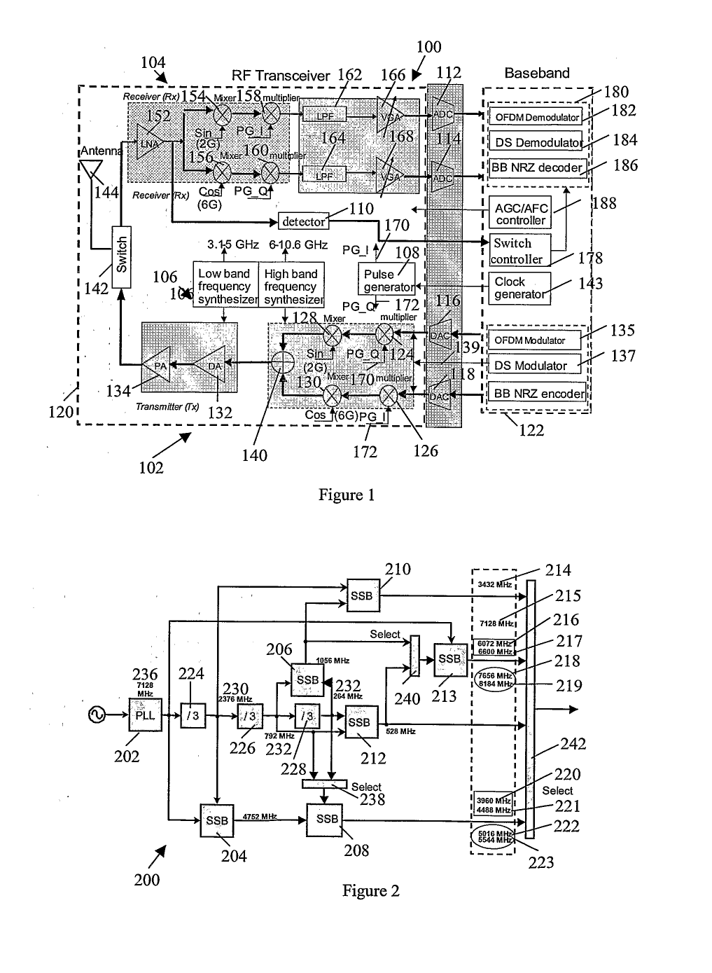

As shown in FIG. 1, the proposed RF transceiver 100 includes a transmitter 102, a receiver 104, a frequency synthesizer 106, a pulse generator 108, and a detector 110. Analog to Digital Converters (ADCs) 112, 114 and Digital to Analog Converters (DACs) 116, 118 are used for interfacing the RF transceiver 120 with a baseband processor 122.

The transmitter 102 includes two multipliers 124, 126, two mixers 128, 130, one driver amplifier 132, and one power amplifier 134. A series analog baseband data sequence is initially de-multiplexed to parallel data through a serial to parallel SIP conversion in the baseband processor 122. The S/P conversion is implemented in the OFDM Modulator 135 or the DS Modulator 137.

The parallel analog data from the DACs 116, 118 can be multiplied with Q and I UWB pulses respectively generated from the pulse generator 108 to form two parallel frequency spreading data sequences, which each occupy at least >500 MHz bandwidth. The two sequences can then be upconverted to different bands by the mixers 128, 130 respectively with a local oscillator (LO) central frequency generated from the multiband frequency synthesizer 106. The frequency upconversion can be an I/Q upconversion or a dual band conversion for MB-OFDM or DS-UWB scheme, respectively. The upconverted signals are combined together at 140 utilising a current or voltage combing circuit 140. A clock generator 143 of the baseband processor 122 is coupled to the I/Q pulse generator 108.

The driver amplifier (DA) 132 is then used to boost the voltage swing of the combined signal. The power amplify (PA) 134 is used to provide sufficient output power to drive the switch 142 and antenna 144.

The receiver 104 includes one low noise amplifier (LNA) 152, two mixers 154, 156, two multipliers 158, 160, two low pass filters (LPFs) 162, 164, and two variable gain amplifiers (VGAs) 166, 168. The LNA 152 is used to amplifier the received UWB signals from antenna 144. The mixers 154, 156 can be employed to downconvert the different band signals to the baseband. The signal after LNA 152 is a dualband/multiband signal. Since the input LO signals for the two mixers 154, 156 are different, the mixer 154, 156 output signals can be differentiated.

Typically, direct I/Q downconversion or dualband downconversion are employed for the MB-OFDM or the DS-UWB scheme respectively. The I/Q multipliers 158, 160 can act as correlators which correlate the downconverted sequences with respective template pulses from the pulse generator 108, and a high processing gain (here output SNR (signal to noise ratio)-to-input SNR) can be achieved once synchronization is set up.

The LPFs 162, 164 are used to extract the desired baseband signal and reject out-of band interference. The VGAs 166, 168 each provide around 60 dB dynamic range so that their output has sufficient swing to drive the ADCs 112, 114. The bandwidth of the LPFs 162, 164 and VGAs 166, 168 should be designed as variable so that the architecture 100 can be used for different standards.

As mentioned above, the frequency synthesizer 106 generates multifrequency LO tones. For MB-OFDM, a total of 14 frequency tones are to be generated. For DS-OFDM, two frequency tones located at the centre of a lower band and a high band are required. By a proper design of the frequency synthesizer 106 architecture, those desired frequency tones can be generated concurrently. Details of the example implementation of the frequency synthesizer 106 will be described in more detail below, with reference to FIG. 2.

The pulse generator 108 can be used to generate UWB pulses for frequency spreading of the baseband signal. Two pulse sequences 170, 172 with different time locations are generated by the I/Q pulse generator 108 for differentiating different bands. Here, the I pulse generator element of the I/Q pulse generator 108 generates one pulse sequence and the Q pulse generator element generates the other pulse sequence.

At the Rx, a detector 174 monitors the received RF signal 176 after LNA 152. The RF signal will be processed in the detector 110 to determine which modulation scheme is used for a current communication, and a switch controller 178 in the baseband processor 122 controls the baseband demodulator 180 to switch to the corresponding demodulation mode modules 182, 184, 186. An AGC (Automatic gain control) and AFC (automatic frequency control) module 188 in the baseband controls the VGAs 166, 168 and the frequency synthesizer 106 in a closed loop.

The ADC/DACs 112, 114, 116, 118 can be employed to interface the RF transceiver 120 with the baseband processor 122. Different specifications such as sampling rate, resolution etc. are set for the different schemes. Details of the specifications in the example implementation will be described below.

The RF transceiver 100 can be configured for usage with different schemes such as MB-OFDM, DS-UWB, and Impulse radio. The data rate and power consumption are scalable by using different numbers and ranges of frequency bands. The details for the three schemes will now be described.

MB-OFDM

A time-frequency interleaved OFDM scheme (TFI-OFDM) is employed for baseband signalling. The 3.1-10.6 GHz UWB frequency band is dived into a number of continuous channels, e.g. 10 or 14 channels with channel spacing 528 MHz. The relationship between the centre frequencies and channel numbers is given by equation (1):

Channel centre frequency=2904+528×n_{ch}(MHz) (1)

where n_{ch}=1, 2, . . . , 14.

The resulting OFDM physical layer (PHY) channel allocation is summarised in Table 1 below.

TABLE 1

| CHNL_ID | Center frequency |
|---|---|
| 1 | 3432 MHz |
| 2 | 3960 MHz |
| 3 | 4488 MHz |
| 4 | 5016 MHz |
| 5 | 5544 MHz |
| 6 | 6072 MHz |
| 7 | 6600 MHz |
| 8 | 7128 MHz |
| 9 | 7656 MHz |
| 10 | 8184 MHz |
| 11 | 8712 MHz |
| 12 | 9240 MHz |
| 13 | 9768 MHz |
| 14 | 10296 MHz |

The dedicated frequency synthesizer 106 generates the frequency tones. Phase-looked-loops (PLLs) and Single-Sideband (SSB) mixers are employed in the frequency synthesizer 106. Details of the example frequency synthesizer 106 for synthesizing the bands 1-10 are shown in FIG. 2. It will be appreciated by a person skilled in the art that and how the architecture shown in FIG. 2 can be directly extended to e.g. 14 channels. In the 10 band frequency synthesizer architecture 200 for the MB-OFDM scheme, only one PLL 202 and five SSB mixers 204, 206, 208, 210, 212 and 213 are used to generate 10 LO signals 214-223. Three dividers (divide by 3) 224, 226 and 228 generate 2376 MHz (at numeral 230), 792 MHz (at numeral 232) and 264 MHz (at numeral 234) signals respectively. The 528 MHz signal can be used as the system clock signal. Through the combination of these three signals (230, 232 and 234) with the PLL generated 7128 MHz signal (at numeral 236), the total of ten LO signals 214 to 223 are generated by the architecture 200 shown in FIG. 2. Selector switches 238, 240 are provided at the input of SSBs 208 and 213 respectively. A switch 242 at the output of the architecture 200 is sued to select between the respective LO signals 214 to 223.

Returning to FIG. 1, in the MB-OFDM configuration, the transceiver 100 adopts I/Q quadrature upconversion and downconversion, with I/Q mixers 128, 130 used in TX, and I/Q mixers 154, 156 used in RX. The quadrature voltage controlled oscillations (VCOs) are provided by the multiband frequency synthesizer 106. Since pulse frequency spectrum spreading and correlation are not needed in MB-OFDM transceivers, the multipliers 158, 160 in Rx can be configured as linear variable gain amplifiers. This can be achieved by feeding a DC level from a DC bias circuit (not shown) to the multipliers 158, 160 instead of pulse input from the pulse generator 108 for each multiplier 158, 160 when used for MB-OFDM transceivers. A variable gain range 0-30 dB can be achieved so that the requirements of the VGAs 166, 168 designs can be greatly relaxed. The multipliers 124 and 126 in the transmitter 102 are also used as VGAs when operated in MB-OFDM mode.

For each channel (subband), the signal bandwidth is 528 MHz and thus in Rx the LPFs 162, 164 −3 dB bandwidth can be set as 264 MHz. The transmitted spectrum preferably has a 0 dBr (dB relative to the maximum spectral density of the signal) bandwidth not exceeding 264 MHz, −12 dBr at 285 MHz frequency offset, and −20 dBr at 330 MHz frequency offset and above. The VGAs 166, 168 dynamic range can be set as 0-30 dB with a bandwidth of ˜300 MHz.

According to the requirement of the FCC (Federal Communications Commission) UWB spectrum mask, if the lower frequency f_{L} of the operating bandwidth for the PA 134 is fixed at 3.1 GHz and the upper frequency f_{U} is varied between 4.8 GHz and 10.6 GHz, assuming that the transmit power spectral density is flat over the entire bandwidth, then the total transmit power P_{TX}(f_{U}) can be expressed as follows:

[symbol]

(2)

Taking f_{U}=10.6 GHz, the PA 134 output power for a full band application can be calculated as −2.5 dBm. Normally, a 6-10 dB PA 134 backoff is needed for a OFDM signal, thus the OIP3 (Output referred third-order intermodulation point) of the PA 134 is around 3.5-7.5 dBm. The PA 134 can be configured as a class A or a class AB amplifier. Power control is effected through the DA 132, and a 2-3 dB control step is preferred.

Since the baseband signal bandwidth is 528 MHz, the ADCs 112, 114 and DACs preferably work on a high sampling rate, e.g. 528 Msamples/s or 1056 Msamples/s. An ADC 112, 114 resolutions of 4-6 bits is preferred for the complex signal processing in the baseband.

Dual Band DS-UWB

The DS-UWB PHY waveform is based upon dual-band BPSK (Binary Phase Shift Keying) and 4-BOK (Bi-orthogonal keying) modulation with band limited baseband data pulses. DS-UWB supports two independent bands of operation. The lower band occupies the spectrum from 3.1 GHz to 4.85 GHz and the upper band occupies the spectrum from 6.2 GHz to 9.7 GHz. Within each band there is support for up to six piconet channels to have unique operating frequencies and acquisition codes. A compliant device is typically required to implement support for piconets channels 1-4, which are in the low band. Support for piconets channels 5-12 is optional. BPSK and 4-BOK are used to modulate the data symbols, with each transmitted symbol being composed of a sequence of UWB pulses. The various data rates are supported through the use of variable-length spreading code sequences, with sequence lengths ranging from 1 to 24 pulses or “chips”.

In the described transceiver 100, dual bands from 3.1 to 4.85 GHz and 6.2 to 9.7 GHz are employed. Notably, the pulse spreading and shaping are done in the analog domain instead of in the digital baseband. Thus the digital information data can be directly converted to modulate UWB pulses through the described analog modulation scheme, and thus the DACs 116, 118 in TX are not required and can advantageously be bypassed (bypass connection 139) in a DS-UWB mode of the transceiver 100. In RX, through analog correlation, the pulse data are demodulated in the analog domain, which advantageously significantly relaxes the design requirement for the ADCs 112, 114. Details of the frequencies spreading and conversion in the example transceiver 100 will now be described.

In the transmitter 102, the parallel baseband data are multiplied with I/Q pulses for frequency direct spreading, where the I and Q pulses for each band have a time interval difference. Here, the I pulse generator element of the I/Q generator 108 generates one pulse sequence and the Q pulse generator element generates the other pulse sequence. The multipliers 124, 126 work as modulators, which modulate the pulses with the digital information bits received via the bypass connection 139. This preferably can reject image and interference signals during the coherent demodulation in RX. Dual-band frequency upconversion and combining are performed on the spread signals utilising mixers 128, 130 and the combiner 140. The transmission data rate can thus be increased by utilizing a wide bandwidth. In the described example, DSB (Double sided-band) p/down-conversion is adopted for the DS-UWB scheme. Assuming the baseband signal x(t) is converted to two parallel signals x₁(t) and x₂(t), the transmitted signal can be represented as:

y(t)=A└x₁(t)×p₁(t)×cos(ω₁t+φ₀)+x₂(t)×p_{Q}(t)×cos(ω₂t+φ₀)┘ (3)

where and represent the respective central frequencies of the dual bands,

represents the I and Q UWB pulses triggered in a time interval of represents the period of the data rate, and A represents the combined gain of DA 132 and PA 134.

In the described example, the generated pulses cover a frequency range (−10 dB bandwidth) from 0.5 to 4 GHz, thus the central frequency is 2.25 GHz. To shift the central frequency to the low frequency band from 3.1 to 4.85 GHz, a 792 MHz LO can be used so that the upconverted frequency is from 1.292 to 4.792 GHz. Through pulse shaping, utilising DA 132, the upconverted frequency can be shaped to the low band from 3.1 to 4.792 GHz (−10 dB band width). Similarly, to shift to the high band from 6.2 to 9.7 GHz, a 6.072 GHz LO can be used so that the upconverted frequency band is from 6.572 to 10.072. The LOs of 792 MHz and 6.072 GHz can be generated form the proposed frequency synthesizer architecture 200 described above with reference to FIG. 2.

In the receiver 150, in each band, frequency downconversion is performed first, followed by coherent correlation. This can be expressed as

$$\begin{matrix}B \times y ( t ) \times cos ( {ω}_{1} t + {ϕ}_{0} ) \times {p}_{I} ( t ) {=}^{LPF} {x}_{1} ( t ) & ( 4 ) \\ B \times y ( t ) \times cos ( {ω}_{2} t + {ϕ}_{0} ) \times {p}_{Q} ( t ) {=}^{LPF} {x}_{2} ( t ) & ( 5 )\end{matrix}$$

where B represents the receiver gain. The baseband signals x₁(t) and x₂(t) are thus recovered, and are converted to a serial sequence x(t) through the parallel to sequential converter implemented in the DS Demodulator 184.

For each band, the LPFs 162, 164 respectively −3 dB bandwidth can be set at half of the data rate, e.g., for 500 Mbps, the LPFs 162, 164 bandwidth is 250 MHz. The VGAs 166, 168, which have a tunable bandwidth and can be used for different modes/standards, have a dynamic range of 0-60 dB with a bandwidth of around 300 MHz. An integrator with small −3 dB bandwidth (e.g. 1 MHz) and large unity gain bandwidth (e.g. 1 GHz) can be designed (together with VGAs 166, 168) so that a longer constant output level can be held for reliable sampling purpose.

Since DSB upconvertion is employed in the described example, a pulse shaping filter is used to reject the image signal and to shape the upconverted and combined UWB signal spectrum. The pulse shaping filter can be designed as the input stage of the DA 132, where the input matching and pulse shaping can be performed concurrently. Advantageously, the DA 132 with a gain 6-10 dB can compensate the loss in the pulse shaping filter. For linearity the PA 134 is preferably configured as a class A type. Since no back off is needed, the PA 134 output power (and the OIP3) is −2.5 dBm for a full band application and −9 dBm for a lower band application.

In the DS-UWB scheme, the ADCs 112, 114 work on a sampling rate equal to the data rate with a resolution 2-4 bits. As mentioned above, the DACs 116, 118 are not required in the DS-UWB scheme and are bypassed.

Carrier-Less UWB

The described architecture 100 can also be configured as a dual band impulse based UWB transceiver. An impulse radio can be designed for each band, and the data rate can be improved by multiplexing the dual-band data. The TX generates pulse position modulated (PPM) UWB high-order derivative pulses that are then emitted by the UWB antenna 144. At the RX, the received pulses are firstly amplified by the LNA 152. The amplified pulses are then correlated with the local pulses, further amplified and integrated to a constant level for ND conversion. It will be appreciated by the person skilled in the art that the integrator can be integrated with the VGAs 166 and 168 as output stage. As such, the signal modulation and demodulation are both completed in the analog domain.

In the transmitter 102, firstly the CMOS I and Q pulse generator elements of the I/Q pulse generator 108 are employed to generate Gaussian monocycle pulses which are the second derivative of Gaussian pulses. With the rising and falling edges of an input digital pulse, positive and negative UWB monocycle pulses occupying the frequency band from 900 MHz to 5 GHz are generated. In order to meet the FCC spectral mask, the pulses are further amplified and shaped. As a result, the output pulses of in TX are shaped into the fifth derivative of Gaussian pulses that meet the 3.1 to 10 GHz FCC mask. Details of the example implementation in the impulse radio mode will now be described.

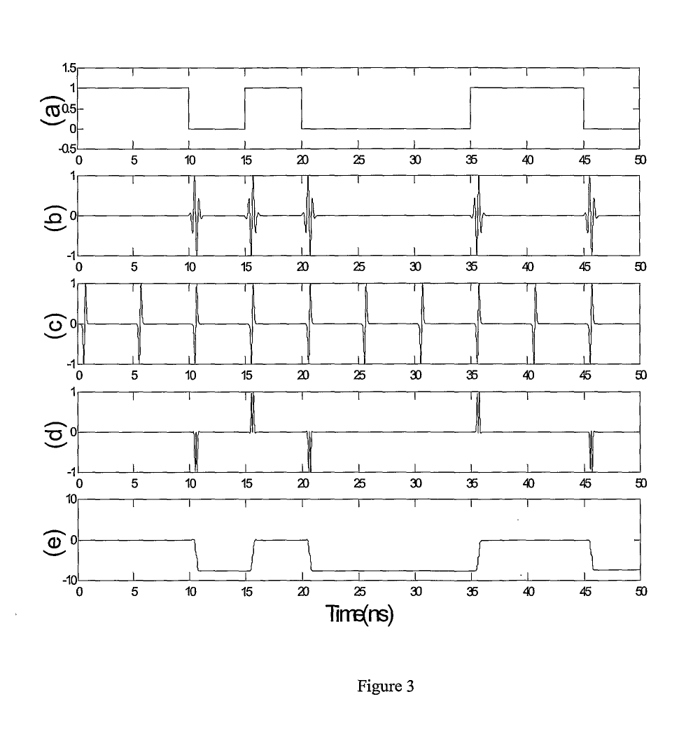

As shown in FIG. 3, a PPM scheme is used to directly modulate the digital baseband signals to UWB pulses. The baseband NRZ (non-return-to-zero) data (curve a) are used to drive the TX PG. Since each pair of input data edges generate a pair of UWB fifth derivative of Gaussian pulses through the TX circuits, the location of the generated pulses (curve b) are therefore modulated by the digital data (curve a). In this scheme, multiplier 124, 126 (FIG. 1) work as a VGA while the UWB fifth derivative of Gaussian pulses are generated due to the bandpass frequency response of the transmitter unit 141 (FIG. 1). At the RX 104 (FIG. 1), the first derivative of the Gaussian pulses (curve c) is generated and synchronized to the received pulses (curve b). The first derivative are generated by the I and Q pulse generator elements of the I/Q pulse generator 108 (FIG. 1). The pulse multiplication of the received pulses (curve b) and (curve c) in multipliers 158, 160 (FIG. 1) generates an intermediate signal (curve d). The integration output (curve e) at ADCs 112, 114 (FIG. 1) (applied to the intermediate signal (curve d)) recovers the transmitted data (compare curves (e) and (a)).

Returning to FIG. 1, since no upconversion/downconversion is needed, the mixers 154, 156 are configured as a linear variable gain amplifier for RF signals. The frequency synthesizer 106 is shut down.

For intermediate frequency (IF) processing the LPFs 162, 164 are used to reject strong out-of-band interference and suppress the leaked high-frequency pulse signals. A third-order elliptic LC ladder filter is implemented with a cut-off frequency of 250 MHz. The LPFs 162, 164 also act as the load of a differential amplifier. A two-stage cascaded variable gain amplifier can achieve a dynamic gain range from −10 to 45 dB with bandwidth 300 MHz. A low-pass feedback loop is employed to reject the DC offset with cutoff frequency 600 kHz. The Gm-C-OTA (Gm-C-Operational Transconductance Amplifier) integrator achieves a low −3 dB bandwidth of 1 MHz and a high unit-gain bandwidth of 1 GHz. This provides a high integration gain and a long holding time. The steady integration value can hold for 10 ns with only <1% error due to circuit charge leakage.

A separate ADC chip employing flash architecture and 4-bit resolution is adopted for further signal processing in the baseband. It is noted that one ADC design with adjustable resolution can be used for the different modes/Standards. A PLL with ring oscillator is used for clock generation in a clock generator 194 while two cascaded delay-locked loops (DLL) are used for synchronization. The two DLLs are capable of delaying the clock with minimum steps of 1 ns and 0.1 ns respectively. During pulse acquisition, the synchronizer, which is included in the BB NRZ decoder 186, in the baseband detects the amplitude of the correlated output and then delays the clock using the DLLs until the correlated output is larger than a pre-determined threshold. Subsequently, an early-late tracking loop is employed to lock the local pulses with the received pulses. Once the synchronization (acquisition and tracking) is sustained, the coherent demodulation will take place. It will be appreciated by the person skilled in the art that a conventional DLL can be used as a reference design for implementation.

The described transceiver can provide a unique architecture which can be adopted for different schemes. The architecture meets with the MB-OFDM scheme in a direct conversion architecture. For the DS-UWB scheme, no baseband pulse shaping is needed thus the power consumption can be reduced. Through introducing a new PPM scheme, the architecture can be used for dual band impulse radio applications.

More particular, the described architecture can provide a unique reconfigurable RF transceiver for MB-OFDM, DS-UWB, and impulse radio. A multitone frequency synthesiser architecture for both MB-OFDM and DS-UWB can be provided. An analog UWB pulse spreading and shaping scheme are used for DS-UWB. A dual band analog DS-UWB modulation and frequency conversion scheme can be provided. Reconfigurable mixers and multipliers for different standards are used. A PPM modulation and demodulation scheme for carrier-less impulse radio can be provided. The described architecture is suitable for scalable data rate applications.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A reconfigurable RF transceiver capable of supporting MB-OFDM, DS-UWB, and impulse radio in different operation modes.

2. The RF transceiver as claimed in claim 1, comprising a multitone frequency synthesiser architecture capable of generating multitones for MB-OFDM and DS-UWB.

3. The RF transceiver as claimed in claim 1, wherein, in a DS-UWB operation mode, pulse spreading and shaping scheme are implemented in the analog domain.

4. The RF transceiver as claimed in claim 1, wherein, in a DS-UWB operation mode, a dual band analog DS-UWB modulation and frequency conversion scheme are implemented.

5. The RF transceiver as claimed in claim 1, comprising a transmitter module comprising reconfigurable digital to analoge converter modules, reconfigurable multiplier modules, and a reconfigurable driver amplifier module, capable of supporting MB-OFDM, DS-UWB, and impulse radio in the different operation modes.

6. The RF transceiver as claimed claim 5, wherein the transmitter module further comprises mixers connected to outputs of the respective reconfigurable multiplier modules, wherein outputs from the respective mixers are combined as an input to the reconfigurable driver amplifier module.

7. The RF transceiver as claimed in claim 5, wherein the reconfigurable digital to analoge converter modules are connected to respective ones of the reconfigurable multiplier modules, with a selectable bypass connection for the reconfigurable digital to analoge converter modules.

8. The RF transceiver as claimed in claim 1, comprising a receiver module comprising reconfigurable multiplier modules, reconfigurable low pass filter modules, reconfigurable variable gain amplifier modules, and reconfigurable digital to analoge converter modules, capable of supporting MB-OFDM, DS-UWB, and impulse radio in the different operation modes.

9. The RF transceiver as claimed claim 8, wherein the receiver module further comprises a low noise amplifier module connected, the output of the low noise amplifier module connected to inputs of respective mixers, outputs of the respective mixers being connected to inputs of the respective low pass filter modules.

10. The RF transceiver as claimed in claim 8, wherein outputs of the respective reconfigurable low pass filter modules are connected to inputs of the respective reconfigurable variable gain amplifier modules, and outputs of the respective variable gain amplifier modules are connected to respective analoge to digital converter modules.

11. The RF transceiver as claimed in claim 1, wherein, in a carrier-less impulse radio mode, a pulse position modulated (PPM) modulation and demodulation scheme are implemented.

12. The RF transceiver as claimed in claim 1, capable of supporting scalable data rate applications.

13. The RF transceiver as claimed in claim 1, coupled to a baseband processor module.
